(19) United States
(12) Patent Application Publication
(10) Pub. No.: US 2026/0086746 A1
(43) Pub. Date: Mar. 26, 2026

(54) INFORMATION PROCESSING DEVICE, INFORMATION PROCESSING METHOD, AND MEDIUM

(71) Applicant: CANON KABUSHIKI KAISHA, Tokyo (JP)

(72) Inventor: YUKINOBU AKADO, Kanagawa (JP)

(21) Appl. No.: 19/330,057

(22) Filed: Sep. 16, 2025

(30) Foreign Application Priority Data
Sep. 24, 2024 (JP) 2024-165653

(51) Int. Cl. G06F 3/12

(52) U.S. Cl. CPC G06F 3/1219; G06F 3/1208; G06F 3/1239; G06F 3/1252; G06F 3/1256; G06F 3/1287

(57) ABSTRACT

An information processing device is configured to arrange a page included in a print job for causing an image output device to execute printing. The information processing device determines whether or not a focused page included in processing target data is a target of margin removal based on a type of an object included in the focused page; and in a case where it is determined that the focused page is a target of margin removal, arranges a drawing region obtained by excluding a margin from an object region of the focused page as a new page on an output sheet.

### BACKGROUND

### Field of the Technology

The present disclosure relates to an information processing device and an information processing method for removing an unnecessary margin in printed matter to save paper used.

### Description of the Related Art

Job submission software that handles a plurality of print jobs performs printing by efficiently executing many jobs. When a plurality of print files are output, the print files may have different output sizes, but even in such a case, there is a need to collectively print the files on respective output sheets corresponding to their output sizes with simple processing. There are various types of output, and examples of the output of a large-sized printer include drawings, posters, and photographs, and job submission software needs to efficiently output those different types of output mainly using rolled paper.

Also, technologies for removing margins have been known (e.g., Japanese Patent No. 6354372). According to Japanese Patent No. 6354372, removal processing is performed at least in one direction on a margin included in image data of one page and extending from the leading end of the page in the conveyance direction of an output sheet and a margin included in the image data and extending from an end of the page in a direction orthogonal to the conveyance direction. Image formation is performed based on image data obtained by performing the margin removal processing. Conditions regarding a position from which image formation is started are stored, and if conditions of the image formation match the stored conditions, a position from which the image formation is started is changed to the position indicated by the stored conditions.

In Japanese Patent No. 6354372, margins included in image data are uniformly identified, and identified margins are removed. Therefore, the invention described in Japanese Patent No. 6354372 has a problem in that, even a necessary blank region included in drawing data may be determined as a margin and removed.

### SUMMARY

The present disclosure provides a technology for removing an unnecessary margin in printed matter to save paper used, and leaving a necessary margin at the same time.

One aspect of the present disclosure provides an information processing device configured to arrange a page included in a print job for causing an image output device to execute printing, the information processing device comprising: at least one memory storing instructions; and at least one processor that is in communication with the at least one memory and that, when executing the instructions, cooperates with the at least one memory to execute processing, the processing including: determining whether or not a focused page included in processing target data is a target of margin removal based on a type of an object included in the focused page; and in a case where it is determined that the focused page is a target of margin removal, arranging a drawing region obtained by excluding a margin from an object region of the focused page as a new page on an output sheet.

With the above configuration, it is possible to remove an unnecessary margin in printed matter to save paper used, and to leave a necessary margin at the same time.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 shows an example of hardware configurations of a PC 100 and an image output device 101.

FIGS. 2A to 2D show an example of a display screen of an application for executing printing.

FIG. 3 shows an example of print setting information included in print jobs.

FIG. 4 shows an example of a flow in which a print job is created by a print application by removing a margin to save paper.

FIG. 5 shows an example in which paper is saved by removing a margin.

FIG. 6 is an example of a schematic diagram showing a colored rectangular region 602.

FIG. 7 shows an example of a hardware configuration including a generative AI system.

FIGS. 8A to 8C show an example in which image data is determined with use of generative AI.

FIGS. 9A to 9C show an example of a result of determination of a colored rectangular region in view of the types of drawing commands.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Embodiment 1

### System Configuration

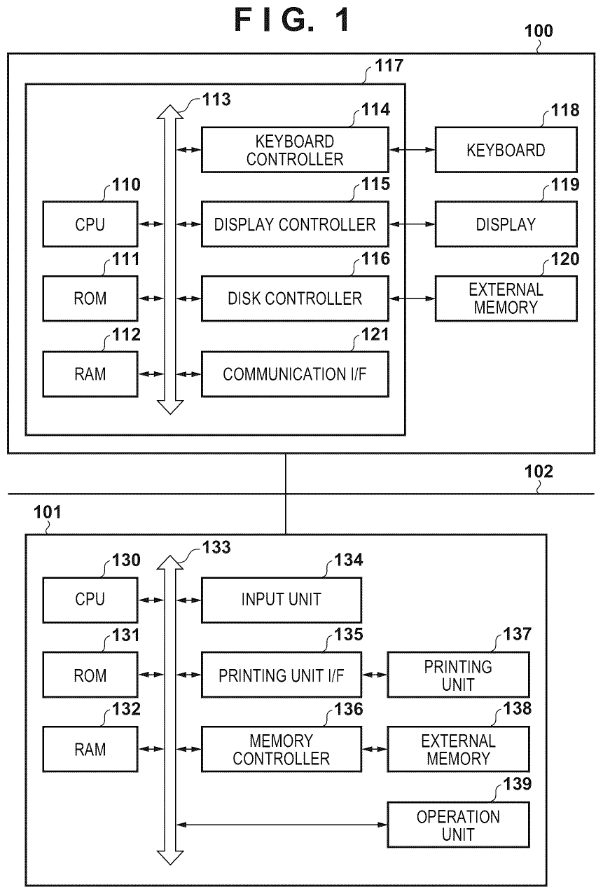

First, the following describes a system configuration according to the present embodiment. A system according to the present embodiment is constituted by a PC 100 in which a print application has been installed, and one or more image output devices 101 shown in FIG. 1. These are connected via bus communication using a USB, for example, or network communication using a network 102, for example. Note that a print application program may also be referred to as “job submission software” or a “print application”.

FIG. 1 shows an example of hardware configurations of the personal computer (PC) 100 and the image output device 101 constituting an image output system. The PC 100 may also be referred to as an “information processing device”, and the image output device 101 may also be referred to as an “image forming device”, a “printer”, or a “printer device”.

First, the following describes the image output device 101. The image output device 101 is controlled by a CPU 130. The CPU 130 may also be referred to as a “processing unit” or a “control unit”. The CPU 130 operates based on a program and the like stored in a program ROM in a ROM 131 or a program and the like stored in an external memory 138. These programs include the print application. The CPU 130 outputs an image signal as output information via a system bus 133 to a printing unit 137 that is connected to a printing unit interface (I/F) 135. The CPU 130 can process communication with the PC 100 via an input unit 134, and notify the PCs of information held in the image output device 101. Also, the CPU 130 can receive output data to be output to the printing unit 137 via the input unit 134. Note that the input unit 134 may be a communication I/F (i.e., a communication unit) for LAN or the like, and is connected to the communication network 102 to which the PC 100 is connected as well. The input unit 134 may output a signal to a communication partner such as the PC 100.

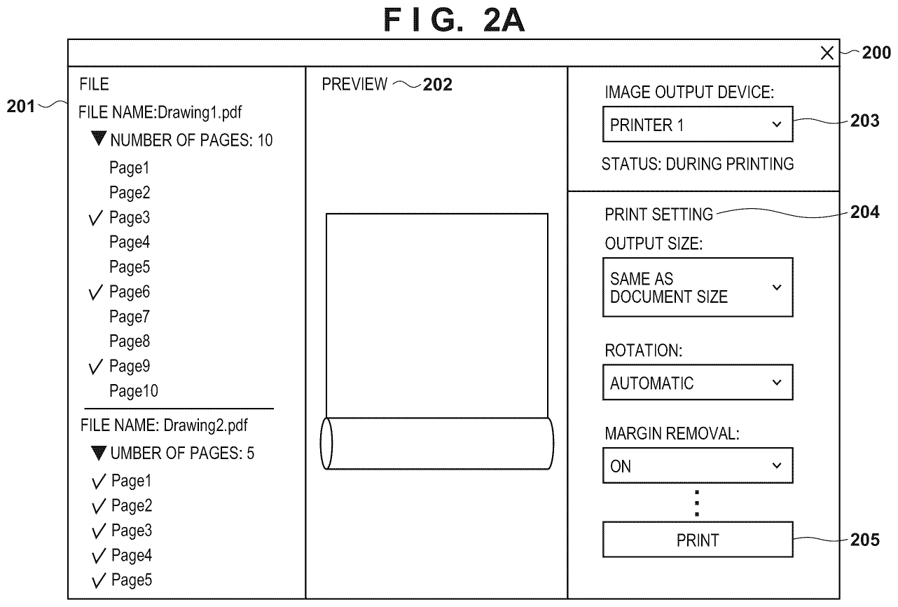

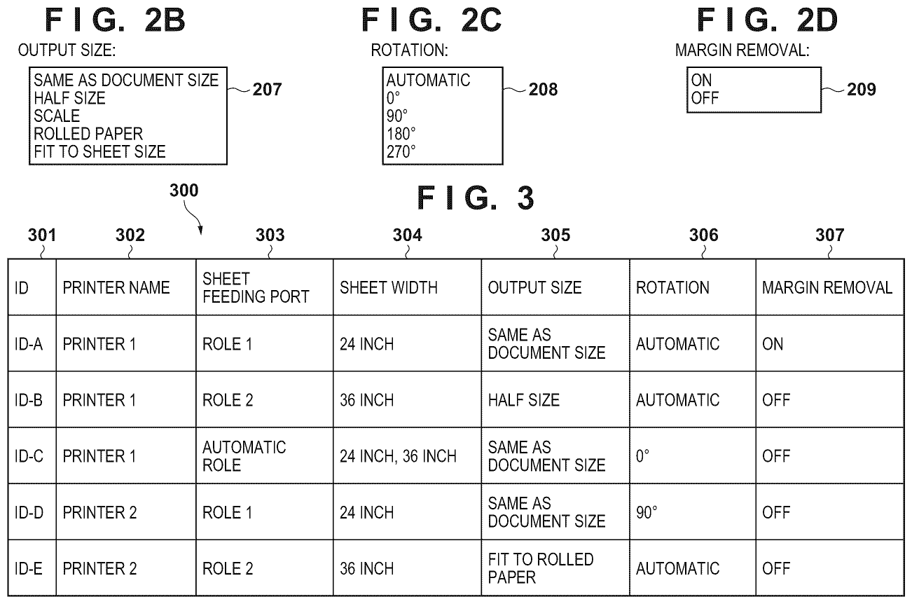

A RAM 132 is a memory that functions as a main memory or a work area for the CPU 130, for example, and is configured such that its memory capacity can be increased by an optional RAM connected to an add-on port (not shown). Note that the RAM 132 is used as an output information developing region, an environmental data storage region, a non-volatile memory, or the like. Access to the external memory 138 such as a hard disk (HDD) or an IC card is controlled by a memory controller 136. The external memory 138 can be optionally connected, and stores font data, an emulation program, form data, information regarding sheets registered in the image output device, attribute information of the sheets, and the like. An operation unit 139 includes an operation panel, can display various types of information such as a user interface screen shown in FIGS. 2A to 2D, and accepts input from a user.

Next, the following describes the PC 100. The inside 117 of the computer includes a CPU 110, a ROM 111, a RAM 112, a keyboard controller 114, a display controller 115, a disk controller 116, and a communication I/F 121. The CPU 110 may read a control program or the like from the ROM 111. The CPU 110 may be a dedicated circuit such as an ASIC. The CPU 110 and a dedicated circuit are examples of a hardware circuit or a hardware processor. Similarly to the CPU 100, the CPU 110 may also be referred to as a “processing unit” or a “control unit”. The disk controller 116 controls access to an external memory 120 such as an HD, a CD-ROM, a DVD-ROM, a USB, or the like. The RAM 112 is configured such that its capacity can be increased by an optional RAM (not shown), for example, and is a memory that is mainly used as a work area for the CPU 110. The keyboard controller 114 controls key input from a keyboard 118 or a pointing device (not shown). The display controller 115 controls display on a display 119. The communication I/F 121 is connected to the communication network 102 and controls communication with an external device that can communicate with the PC 100. In the embodiment of the present disclosure, the CPU 110 controls each unit connected to a main bus 113 via the main bus 113, unless otherwise stated.

FIGS. 2A to 2D show an example of a display screen that is displayed when the print application installed in the PC 100 is executed. In a main screen 200 of the print application, the name of an output data file (which is called a print target file) that is a print target and the configuration of pages included in the file are displayed in a file display section 201. The print target file may be selected as a parameter when the print application is executed, or may be selected by the user by designating the file name in the file display section 201. A configuration is also possible in which the file names of files stored in a predetermined folder are displayed as candidates in a pop-up, for example, and the print target file can be selected from the candidates.

A preview display section 202 displays a print preview of each page of the selected print target file displayed in the file display section 201. The content of each page is referred to as an “image” or a “document”, and data of the content is referred to as “image data” or “document data”. Pages included in document data are referred to as “document pages”, and data corresponding to the document pages is referred to as “document page data”. Also, an image output device to which a print job is transmitted can be selected in an image output device designation section 203, and the name of a selected image output device is displayed therein. Each item included in print settings can be selected from alternatives in a print setting section 204, for example, and various selected print setting items are displayed therein. The print setting section 204 includes an output size designation section 207 (FIG. 2B) for setting an output size, a rotation designation section 208 (FIG. 2C) for designating rotation of the document, and a margin removal designation section 209 (FIG. 2D) for designating removal of unnecessary margins in printed matter, for example. Examples of setting values that are set for the respective setting items are shown in FIG. 3, which will be described later. When the user operates the print setting section 204 to change a print setting, a preview obtained by applying the changed print setting to the print target file is displayed in the preview display section 202. One or more pages are displayed at the same time in the preview display section 202, and previews of pages that are not displayed can be displayed using a page forward button or a page reverse button (not shown). Thus, the user can check a preview of output that corresponds to the print settings and will be formed on a sheet by the image output device shown in the image output device designation section 203, and accordingly, it is possible to prevent a print failure.

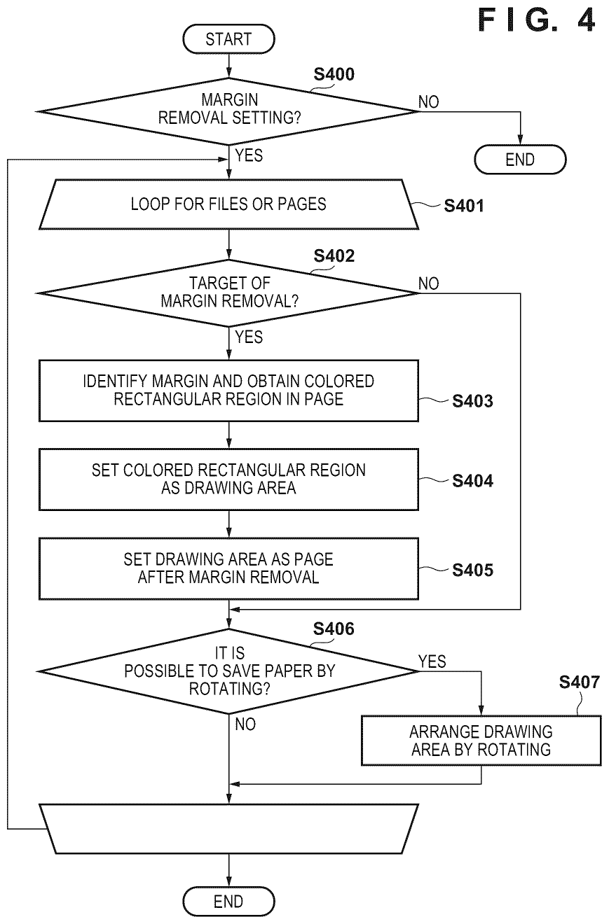

A print button 205 is a button for giving an instruction to start printing. In response to the print button 205 being pressed, the CPU 110 creates a print job including print setting information from a print target file in accordance with print settings designated in the print setting section 204, and transmits the created print job to the image output device shown in the image output device designation section 203. Note that pressing a button means, for example, clicking or tapping a button displayed on a display panel. The print settings designated in the print setting section 204 displayed in the user interface shown in FIG. 2A are temporarily stored and are referred to in a procedure shown in FIG. 4, for example. Also, in response to the print button 205 being pressed, those print settings are stored as print setting information, an example of which is shown in FIG. 3.

FIG. 3 shows an example of print setting information 300 included in a print job created by the print application executed by the CPU 110, i.e., created by the CPU 110 in response to the print button 205 being pressed by the user. Although FIG. 3 shows print setting information regarding a plurality of jobs, print setting information regarding a single job may be created in response to each print instruction, and the created print setting information may be additionally recorded in the print setting information 300. The print setting information 300 includes ID 301 that is identification information of a print job, printer name 302 indicating an image output device to which the print job is output, sheet feeding port 303, sheet width 304 set for the sheet feeding port 303, output size 305, rotation setting 306, and margin removal setting 307, for example. Other print setting information may be added to the print setting information shown in FIG. 3, or some of the print settings shown in FIG. 3 may be omitted from the print setting information 300. When a print target file is selected and a print instruction is given, the print setting information 300 shown in FIG. 3 is generated, and accordingly, the name of the print target file may be associated with identification information of the print job, although this is not shown.

A value set in the image output device designation section 203 included in the main screen 200 shown in FIG. 2 is recorded and held as the printer name 302 shown in FIG. 3. A configuration is possible in which the sheet feeding port 303 and the sheet width 304 can be set via entry fields (not shown) included in the print setting section 204 on the main screen 200 shown in FIG. 2A. Values set in the output size designation section 207, the rotation designation section 208, and the margin removal designation section 209 shown in the print setting section 204 are recorded and held as the output size setting 305, the rotation setting 306, and the margin removal setting 307, respectively. “Auto” that allows the print application to rate an image as appropriate, or a designated rotation angle is set as the rotation setting 306, for example. A configuration is possible in which the allowed rotation angle is either 0 degrees or 90 degrees, or it is possible to set multiples of 90 degrees. Either “ON” indicating to perform margin removal processing or “OFF” indicating not to perform the margin removal processing is set as the margin removal setting 307.

As described above, settings such as the sheet width, the output size, rotation of an image, and margin removal are recorded as the print setting information 300 with respect to each print job.

### Margin Removal and Rotation Processing of Print Application

FIG. 4 is an example of a flow showing a part of processing executed by the print application, in particular, a part of processing in which the CPU 110 creates a print job that saves paper by removing a margin in the ROM 111 or the RAM 112 by executing the print application. In this procedure, in particular, a margin of a document page is removed to reduce the size of the document page. This flow is started at a timing at which the CPU 110 starts to create a print job in response to the print button 205 being pressed by the user, or a timing at which the CPU 110 draws the preview display section 202 again. The timing at which the preview display section 202 is drawn again includes a case where any setting that is included in the print setting section 204 and affects the preview is changed. The procedure shown in FIG. 4 is realized by the CPU 110 by loading a program, e.g., the print application from the external memory 120 into the RAM 112, for example, and executing the program.

First, in step S400, the CPU 110 determines whether or not the margin removal setting 307 is ON, i.e., whether or not the margin removal setting is set for a print target file. If it is determined that the margin removal setting is set, the processing proceeds to step S401, otherwise the processing ends.

In steps from S401 to S407 in this flowchart, determination is performed with respect to each file or each page. In this example, a print job is associated with a print data file, using an identification number of the print job, for example, and the print data file includes one or more pages. Note that a configuration is also possible in which data of a single page constitutes a single file, and one or more files constitute a single job. The processing shown in FIG. 4 is repeated until the CPU 110 finishes the processing on selected pages of the print data file selected in the file display section 201. When the print target file is selected and an execution instruction is given, the print setting 204 shown in FIG. 2A, the output size setting 207 shown in FIG. 2B, the rotation setting 208 shown in FIG. 2C, and the margin removal setting 209 shown in FIG. 2D are referred to, for example.

In step S401, the CPU 110 determines whether or not the print target file includes a page that has not been processed, and if there is an unprocessed page, focuses on the page, otherwise ends the processing.

In step S402, the CPU 110 determines whether or not the focused file or the focused page is appropriate as a target of margin removal. Note that a margin that is to be removed is a blank region on an outer periphery of a drawing region in which letters or image graphics are drawn. For example, if it is determined in step S402 that the focused page (file) is a drawing file (drawing data), it is possible to determine that the focused page (file) is a target of margin removal because it is possible to determine that a blank region is unnecessary for drawings. On the other hand, if the focused page is an image data file, the target of printing is often a photograph or a graphic art, and accordingly, even if there is a margin in the focused page, it is not always appropriate to remove the margin. Therefore, it is possible to determine that an image data file is not a target of margin removal. This is because a photograph or a graphic art design is sometimes composed so as to include a blank region.

A drawing file can be determined based on a file format that is often used to output drawings, for example. For example, it is possible to determine that the focused page is a drawing file based on the fact that the focused page is a PDF file, an HPGL/2 file, or in any other format that is used for a saved file of a drawing output application. In another example, it is possible to adopt a determination method in which the determination is performed if “Auto” is set as the setting value of the margin removal 307 and margin removal is always performed if “ON” is set for the margin removal 307. On the other hand, image data can be determined based on a file format that is used to save image data, such as JPEG or TIFF, or any other file format that is used to save output data of a graphics production application. In any case, the format can be identified based on the file name (e.g., in particular, an extension), and accordingly, the determination in step S402 can be performed based on the file name of the focused file. A configuration is also possible in which whether the focused file is either type of a drawing file and an image file is determined, and if the focused file is not that type of file, it is determined that the focused file is the other type of file. It is also possible to use criteria other than the above criteria to perform the determination in step S402. If the determination result in step S402 is Yes, i.e., if the focused file or page is a target of margin removal, the processing proceeds to step S403, and if the determination result is No, the margin removal processing will not be performed, and the processing proceeds to step S406.

Note that, it is assumed in step S402 that each page to be printed in the print job is an independent file, but a single file may include a plurality of pages, as is the case with a PDF file, for example. In the case of such a file configuration, it is possible to determine the type of the file including the focused page in step S402. For example, in FIGS. 2A to 2D, the print target file is a PDF file named Drawing1.pdf and includes pages 1 to 10. In such a case, in step S402, whether or not each page included in the file is a target of margin removal may be determined based on the file name of the print target file.

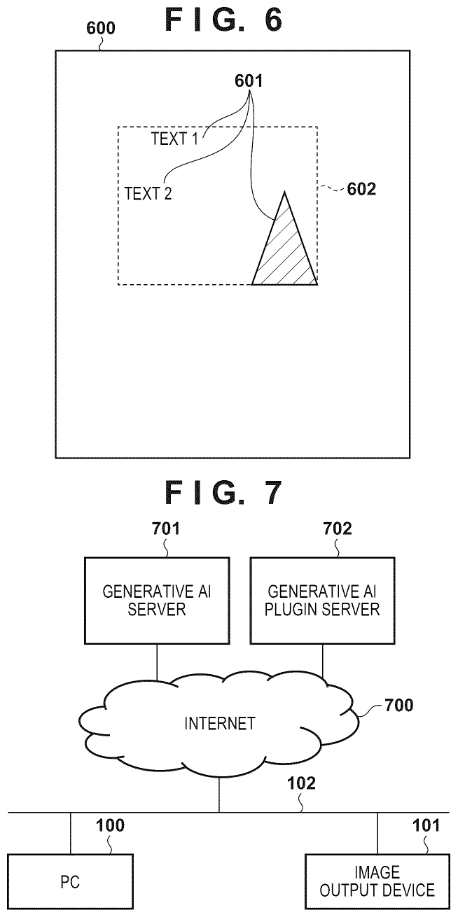

In step S403, the CPU 110 identifies a margin in at least one direction out of the upper, lower, left, and right sides of document data of the focused page, and obtains a colored rectangular region in the page, which is the minimum rectangular region excluding the margin, by calculation. The colored rectangular region, which will be described in detail with reference to FIG. 6, is the minimum circumscribing rectangle that encompasses all drawing objects in the page.

In step S404, the CPU 110 sets the obtained colored rectangular region as a drawing area (or a print region) in the page.

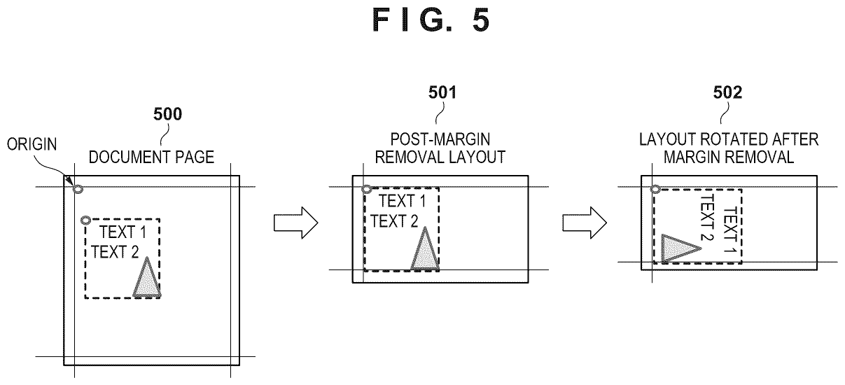

In step S405, the CPU 110 arranges the drawing area set in step S404 as a new page on an output sheet. In an example shown in FIG. 5, the drawing area is arranged such that the drawing area does not overlap a print margin in which no image is formed by the image output device 101. However, a configuration is also possible in which there is no print margin according to setting values of the output sheet, for example, and the drawing area is arranged using, as a reference point, an intersection (which is called a “sheet origin”) between the upper side of the output sheet in the conveyance direction and the left side of the output sheet on the left relative to the upper side. In FIG. 5, a post-margin-removal layout 501 schematically shows a result of processing performed in steps S402 to S405 on a document page 500 that is a page of document data. It can be found that margins are removed and regions of the sheet used are saved.

In step S406, the CPU 110 determines whether or not the area of paper used becomes smaller if the drawing area is rotated. When printing is performed on rolled paper, the paper is cut into the size of the printed matter, and accordingly, the consumption of the paper becomes smaller as the length of the printed matter in the conveyance direction becomes shorter. Therefore, an area of paper (an area of sheet) used when the drawing area is not rotated and an area of paper used when the drawing area is rotated by 90 degrees are compared, and it is determined in which case, the area of paper used is smaller. Although the area of paper used is described as an example, it is also conceivable to use another method in which blank regions outside the drawing area are compared. Alternatively, the length in the vertical direction (the conveyance direction) and the length in the horizontal direction (a width direction orthogonal to the conveyance direction) of the focused page may be compared with each other, and if the length in the vertical direction is longer and is not larger than an output width after rotation, it is possible to determine that the paper can be saved by rotating the focused page by 90 degrees. In the present embodiment, the determination regarding rotation is performed as an example of a case where “Auto” is selected as the rotation setting 306 shown in FIG. 3, but the determination as to whether or not to rotate the drawing area does not necessarily have to be performed. Such a case corresponds to a case where a rotation direction is explicitly designated by the rotation setting 306 shown in FIG. 3, i.e., the rotation direction is designated within a range from 0 degrees to 270 degrees. If it is determined that the paper cannot be saved even if the drawing area is rotated, i.e., if the area of paper used is smaller when the drawing area is not rotated, the processing returns to step S401. In step S401, if there is a file or page that is a target of the processing and has not been processed, the processing is repeated from step S402. On the other hand, if it is determined that the paper can be saved if the drawing area is rotated by 90 degrees, i.e., if the area of paper used becomes smaller when the drawing area is rotated by 90 degrees, the processing proceeds to step S407.

In step S407, the CPU 110 arranges the drawing area obtained by removing the margin from the document page by rotating the drawing area by 90 degrees. After step S407, the processing returns to step S401. Note that, in FIG. 5, a layout 502 rotated after margin removal schematically shows the processing performed in steps S406 and S407. The rotated drawing area is also arranged such that a print margin is provided around the drawing area. Note that the rotation direction may be determined according to subsequent processing such as binding, wrapping, or the like, or may be determined based on other criteria. Also, the rotated document data is arranged such that a new document data origin after the rotation coincides with a print region origin.

If it is not determined in step S402 that the focused page is a target of margin removal, the processing branches to step S406, and if it is possible to save the paper consumption by rotating the document page, the document page is rotated in step S407.

As described above, in the procedure shown in FIG. 4, if the margin removal setting has been set, whether or not the focused page is a target of the margin removal is determined. If the page is a target of the margin removal, a drawing region (a colored rectangular region) obtained by excluding a margin from the focused page is reconstructed as a new page. Particularly when the page is arranged on rolled paper, it is possible to thus save the paper by an amount corresponding to the margin. Also, it is possible to prevent the occurrence of a situation in which margins are removed indiscriminately and even a margin that constitutes an image is removed.

When print settings of the focused page are set and the page is arranged in accordance with the print settings in the procedure shown in FIG. 4, a preview image in accordance with the settings is displayed in the preview section 202. Also, each document page subjected to the margin removal and the rotation processing and information regarding the arrangement of the document page and the like are saved and transmitted to the image output device 101 as a part of a print job together with the print setting information 300 shown in FIG. 3 in response to a print instruction.

A configuration is also possible in which, in the procedure shown in FIG. 4, a preview of the focused page, which is the result of the processing, is displayed with respect to each focused page, and the processing is performed on the next page upon an instruction is given from the user to proceed to the next page in response to the display of the preview, for example.

### Colored Rectangular Region

FIG. 6 shows details of the colored rectangular region obtained in step S403. A colored rectangular region 602 shows a rectangular region in which there are drawing objects 601 in document page data 600. The drawing objects 601 show letters, graphics, image data, and the like. The colored rectangular region 602 is defined as a region obtained by surrounding a region in which a drawing object (a part where the drawing color is not white or a part that is not a blank) appears first when the document page data 600 is scanned from an end of at least one of its upper, lower, left, and right sides. If the document page data is a dot image, for example, the scanning may be performed for each line, for example. Alternatively, if the document page data is data that defines the position of an object, it is possible to determine points that are the closest to respective sides based on the position and spread of the object. There is no drawing object outside the colored rectangular region, and accordingly, the outside of the colored rectangular region can be regarded as a margin region, and the paper can be saved by removing the margin region. This method is realized by a technology similar to that shown in FIG. 6 of Japanese Patent No. 6354372, which shows an example of a position from which image formation is started by an image forming device according to a conventional technology, but it is also possible to use another method.

As described above, a preview showing the layout of document data of each page of the print target file is displayed, print data corresponding to the preview is created, and a print job for causing the image output device to execute printing of the print data is created. The print job is transmitted from the PC 100 to the image output device 101 and executed, and printed matter in accordance with the created print data is output by the image output device 101.

As described above, according to the present embodiment, in the case where the margin removal setting is set, each document page that is to be printed is focused on, and whether or not the document page is a target of the margin removal is determined based on the type of file (determined directly from the extension). If the document page is a target of the margin removal, the document page from which a margin has been removed is thereafter arranged such that the origin of the document page coincides with an image formation start position. In this series of processing, steps S400 to S402 correspond to determination processing for determining whether or not a focused page included in processing target data is a target of margin removal. Also, it can be said that steps S403 to S405 correspond to arrangement processing for arranging a drawing region obtained by removing a margin of the focused page that is determined as a target of the margin removal, using a first reference position as a reference point.

According to this processing, even if the margin removal setting is set, a margin that should not be removed is kept from being removed. Moreover, as for a target of the margin removal, wasting of a printing medium is suppressed and the use efficiency of the printing medium is increased. Furthermore, with respect to each page, whether or not the use efficiency of the printing medium increases when the page is rotated by 90 degrees is determined, and if the use efficiency increases, the document page is arranged by being rotated. For these reasons, wasting of the printing medium is suppressed and the use efficiency of the printing medium is increased.

As described above, the above embodiment can provide a margin removal function that solves the problem by not executing the margin removal on data of which a margin should not be removed in the execution of the margin removal function. The result of the margin removal is displayed in the preview display section 202. Therefore, the user can check the preview display section 202, and change the margin removal setting 209 to OFF upon determining that the margin should not be removed, and check the result in the preview display section 202. Accordingly, it is possible to confirm that an intended output result will be surely obtained before execution of the printing.

### Embodiment 2

The present disclosure is not limited to the above embodiment. For example, in Embodiment 2, a method is conceivable in which artificial intelligence called generative AI is used for the determination of a target of margin removal in step S402 to determine whether or not the content of document page data corresponds to image data.

FIG. 7 shows a relationship between the system configuration of Embodiment 1 described with reference to FIG. 1 and a generative AI system. The PC 100 and the image output device 101 are connected in a communication-enabling manner to the Internet 700 via the network 102. A generative AI server 701 and a generative AI plug-in server 702 are servers managed by a business operator that provides a generative AI service, and are connected in a communication-enabling manner to the Internet 700. Although a configuration in which the generative AI plug-in server 702 is used is shown in the present embodiment, a configuration that does not include the generative AI plug-in server is also conceivable.

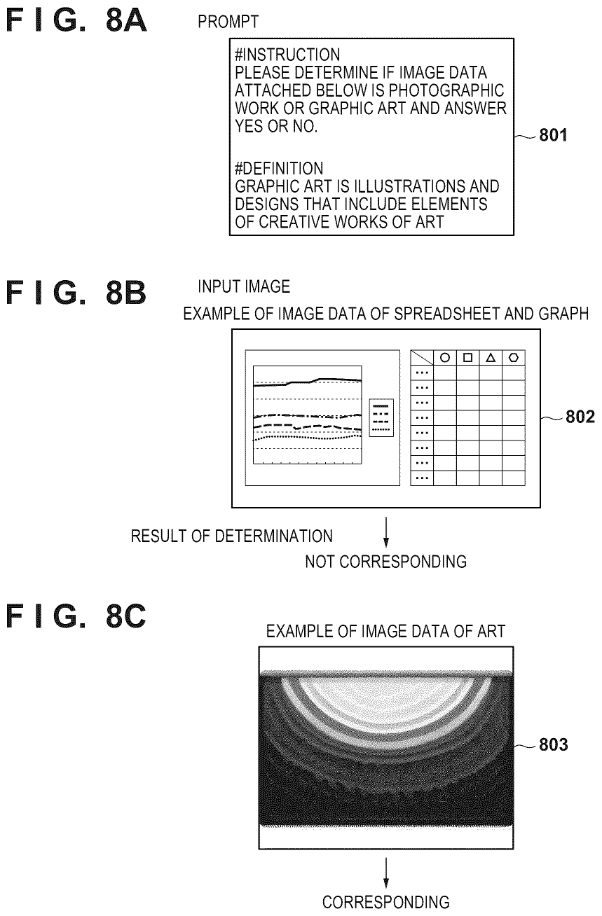

FIGS. 8A to 8C show an example in which generative AI is used to determine a target of margin removal in step S402. A prompt 801 shown in FIG. 8A is an example of an instruction text given using a natural language from the CPU 110 to the generative AI server 701 via the generative AI plug-in server 702. This instruction text gives an instruction to determine whether or not an input image 802 or 803 (FIG. 8B or 8C) that is subsequently transmitted from the CPU 110 to the generative AI server 701 is image data that is not a target of margin removal. In response to this instruction, the generative AI server 701 transmits, to the CPU 110, a response indicating whether or not the input image corresponds to such image data based on a learned model in the generative AI server 701. If the response includes a result indicating that the input image does not correspond to such image data, the CPU 110 determines in step S402 that the input image is a target of margin removal. For example, it is determined that image data including a spreadsheet and a graph like an input image 802 does not correspond to such image data, and consequently, it is determined that the image data is a target of margin removal. In this case, the processing proceeds to step S403.

In the opposite case, image data is not a target of margin removal, and therefore, the processing proceeds to step S406. For example, as for data of an art image like an input image 803, the CPU 110 receives a determination result indicating that the data corresponds to such image data, and determines that the data is not a target of margin removal.

In the above example, a learned generative AI is used, but it is also possible to create a new learned model and cause the learned model to determine whether or not a processing target page is a target of margin removal. The following describes an example in which a neural network is used for this purpose.

### Outline of Neural Network

A method for realizing AI is machine learning performed using a neural network. A neural network is composed of an input layer, one or more intermediate layers, and an output layer, for example. In an example of such a typical configuration, each layer includes a plurality of nodes, and each node is connected to one or more other nodes. Each node has a threshold and a weight as parameters, and when an output of a node included in a layer exceeds the threshold, weighted data is transmitted to a node included in the next layer. Data is propagated in this manner from the input layer, to which the data is input, to the intermediate layers and the output layer, and thus an output is obtained. In the neural network, parameters such as the threshold and weight of a signal output from each node are adjusted by learning, and the configuration of each layer and the parameters such as the weight are obtained as a learned model. When the learned model is created, it is possible to obtain a processing result from the output layer by inputting data to the input layer as described above.

When determination performed in this example as to whether or not the processing target can be a target of margin removal is applied to such a neural network, it is possible to use, as teacher data, page data that is a printing target and data indicating whether or not each page data is a target of margin removal, for example. By causing a learning model to learn using such teacher data, and inputting page data, it is possible to create a learned model that outputs whether or not the page is a target of margin removal. Then, the learned model can be used to determine whether or not each page is a target of margin removal. In the example using the generative AI, the generative AI, which is an existing learned model, is used to determine whether or not data included in a page is either a photographic work or a graphic art, and if the data is a photographic work or a graphic art, it is determined that the data is not a target of margin removal. On the other hand, if the learned model created as described above is used, it is possible to not only perform the determination as to whether the data is either a photographic work or a graphic art, or any other data, but also perform more detailed determination.

As described above, the above embodiment can provide an image processing device that determines whether or not to execute margin removal with high accuracy by letting the generative AI server 701 determine the content of a drawing object.

### Embodiment 3

The present disclosure is not limited to the above embodiments. For example, in Embodiment 1, whether or not a focused page is a target of margin removal is determined in step S402, and if it is determined that the page is a target of margin removal, processing for calculating a colored rectangular region is performed in step S403, taking all drawing objects included in the page to be the target of margin removal. However, a case is also conceivable in which some drawing objects included in the page correspond to image data and should be excluded from the target of margin removal.

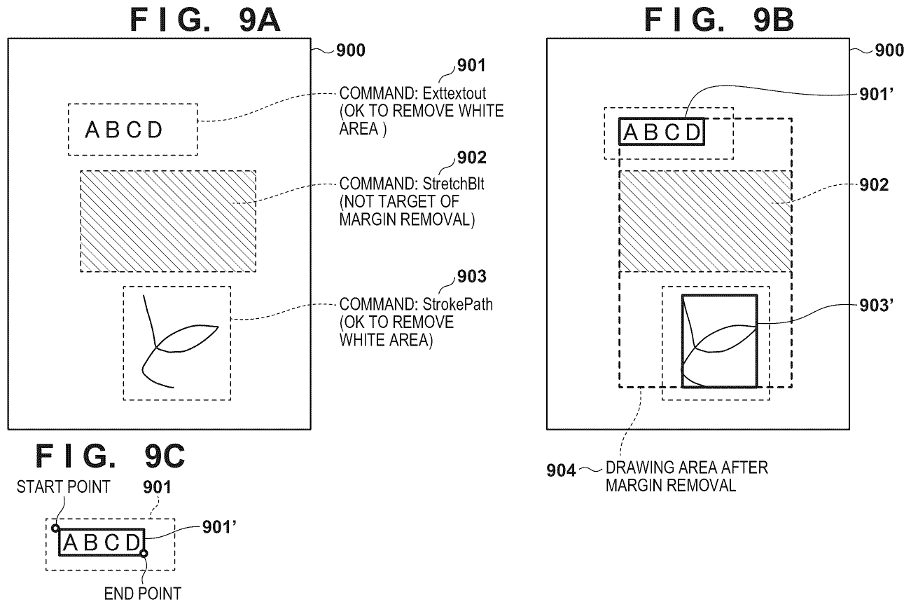

FIGS. 9A to 9C schematically show a state where determination of a drawing rectangular region is switched for each type of drawing command when obtaining a colored rectangular region in step S403. As for the colored rectangular region 602 shown in FIG. 6, an outermost peripheral region of colored coordinates in the up-down direction and the left-right direction is determined as the colored rectangular region, but in the present embodiment, processing is changed according to the type of drawing command.

As shown by objects and command regions on a page 900 shown in FIG. 9A, a text drawing command 901 (text object) and a graphic drawing command 903 (graphic object) are not image data. Accordingly, as in Embodiment 1, the CPU 110 determines colored regions included in these object regions (if the drawing color is not white or the regions are not line breaks) as drawing regions of the objects. Here, the term “object region” means a region drawn by the drawing command of the object, and includes a blank (margin) rendered in its peripheral edge portion. The object region is also called a command region. For example, the object region of a text drawing command may include a blank region surrounding the text and rendered together with the text. This applies not only to the text drawing command but also to other commands such as a graphic drawing command. In FIGS. 9A to 9C, the text drawing command 901 corresponding to a text object is Exttextout command, and the graphic drawing command 903 corresponding to a graphic object is Strokepath command.

More specifically, it can be found that the object regions of the text drawing command 901 and the graphic drawing command 903 are regions including margins surrounding the drawing objects with dotted lines showing rectangular outer peripheries of the commands. A region 901′ (see FIG. 9C) obtained by excluding margins forms the outline of a drawing region to which a drawing color is applied. The drawing region may be a rectangle formed by sides that are parallel to the sides of the page including the drawing region. Accordingly, even when a text slanting with respect to the sides of the page is drawn by a text drawing command, for example, the drawing region may be a rectangular region that circumscribes the text and is formed by sides that are parallel to the sides of the page.

On the other hand, as for an image drawing command 902, the CPU 110 determines that the entire region inside dotted lines showing the outer periphery is a drawing region, and does not perform determination on the color of the inside region. In FIGS. 9A and 9B, the image drawing command 902 is StretchBlt command, for example.

FIG. 9B shows an example of drawing regions determined by applying the above description to the entire page. The CPU 110 obtains the largest values and the smallest values of colored vertical coordinates and colored horizontal coordinates of the drawing regions of the respective commands, as a colored rectangular region in the page. In the specific example shown in FIG. 9B, the vertical and horizontal coordinates of a start point and an end point of each of the drawing regions 901′, 902, and 903′ in the command regions are determined by calculation or the like. A rectangular region showing a drawing area 904 after margin removal is a rectangular region whose upper left corner point and lower right corner point in FIGS. 9A to 9C are indicated by the smallest values of the vertical and horizontal coordinates of the start points of the drawing regions of the respective commands and the largest values of the vertical and horizontal coordinates of the end points of the drawing regions. That is to say, the minimum rectangular region that is formed by sides parallel to the sides of the original page and includes all the drawing regions in the command regions included in the page is the drawing region after margin removal.

When the processing described above is applied to FIG. 4, the CPU 110 determines in step S402 whether or not the focused page includes an object that is a target of margin removal, other than an image object. If it is determined that the focused page includes such an object, the processing proceeds to step S403. In step S403, the CPU 110 identifies a colored rectangular region obtained by excluding a margin from the object that is a target of margin removal in the focused page, and identifies the minimum rectangular region that includes all object regions included in the focused page. In step S404, the CPU 110 sets the objects included in the identified rectangular region as a drawing area. In step S405, the CPU 110 sets the drawing area as a new page after margin removal.

Note that page description languages such as PDF, PS, HPGL/2, Windows GDI·DDI commands are conceivable as the types of drawing commands, but it is also possible to use drawing commands of other command systems. For example, in the case of Windows GDI commands, examples of the text drawing command include ExtTextOut, examples of the graphic drawing command include StrokePath and FillPath, and examples of the image drawing command include StretchBlt and StretchDIBits, but other commands may be included, or only some of these may be used.

As described above, in the above embodiment, whether or not there is a target of margin removal is determined based on drawing commands, and therefore, even if image data is included in a part of a page, the image data can be excluded from the target of margin removal, and it is possible to provide an image processing device that suppresses inappropriate removal of margins.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-165653, filed Sep. 24, 2024, which is hereby incorporated by reference herein in its entirety.

What is claimed is:

1. An information processing device configured to arrange a page included in a print job for causing an image output device to execute printing, the information processing device comprising:
at least one memory storing instructions; and
at least one processor that is in communication with the at least one memory and that, when executing the instructions, cooperates with the at least one memory to execute processing, the processing including:
determining whether or not a focused page included in processing target data is a target of margin removal based on a type of an object included in the focused page; and
in a case where it is determined that the focused page is a target of margin removal, arranging a drawing region obtained by excluding a margin from an object region of the focused page as a new page on an output sheet.

2. The information processing device according to claim 1,
wherein the determining includes determining that the object region is a target of margin removal if the type of the object is not an image.

3. The information processing device according to claim 2,
wherein the determining includes identifying the type of the object based on a name of a data file including the focused page.

4. The information processing device according to claim 2,
wherein the determining includes determining that the type of the object is an image if the object region includes an image drawing command.

5. The information processing device according to claim 2,
wherein the determining includes determining that the type of the object is not an image if the object region includes a text drawing command or a graphic drawing command.

6. The information processing device according to claim 2,
wherein the determining includes determining, with respect to each object region included in the focused page, whether or not the object region is a target of margin removal based on a type of an object, and
the arranging includes taking a drawing region obtained by excluding a margin from an object region that is determined as a target of margin removal, as a new object region, and arranging a rectangular region that circumscribes all object regions included in the focused page, as a new page.

7. The information processing device according to claim 1,
wherein the processing further includes rotating the drawing region of the focused page by 90 degrees and arranging the rotated drawing region, if an area of the sheet becomes smaller when the drawing region of the page arranged in the arranging is rotated by 90 degrees.

8. The information processing device according to claim 1,
wherein the determining includes determining whether or not margin removal setting is set for the processing target data, and if the margin removal setting is set, determining whether or not the focused page is a target of margin removal based on the type of the object included in the focused page.

9. The information processing device according to claim 1,
wherein the processing further includes displaying the focused page arranged in the arranging.

10. The information processing device according to claim 1,
wherein the processing further includes, in response to an instruction from a user, creating a print job including arrangement of the focused page arranged in the arranging, and transmitting the print job to an image forming device.

11. A non-transitory computer-readable storage medium storing a program that, when loaded into a computer and executed, causes the computer to execute processing for arranging a page included in a print job for causing an image output device to execute printing, the processing including:
determining whether or not a focused page included in processing target data is a target of margin removal based on a type of an object included in the focused page; and
in a case where it is determined that the focused page is a target of margin removal, arranging a drawing region obtained by excluding a margin from an object region of the focused page as a new page on an output sheet.

12. An information processing method performed by an information processing device to arrange a page included in a print job for causing an image output device to execute printing, the information processing method comprising:
determining whether or not a focused page included in processing target data is a target of margin removal based on a type of an object included in the focused page; and
in a case where it is determined that the focused page is a target of margin removal, setting a drawing region obtained by excluding a margin from an object region of the focused page as a new page.
